(19) United States
(12) Patent Application Publication
(10) Pub. No.: US 2016/0343522 A1
(43) Pub. Date: Nov. 24, 2016

(54) EMBLEM INTEGRATED TRUNK SWITCH MODULE

(71) Applicants: Hyundai Motor Company, Seoul (KR); DaeDong, Ansan-si (KR); Kia Motors Corporation, Seoul (KR)

(72) Inventors: Kwan Hui KANG, Hwaseong-si (KR); Joong Un PARK, Seoul (KR)

(21) Appl. No.: 14/961,290

(22) Filed: Dec. 7, 2015

(30) Foreign Application Priority Data
May 22, 2015 (KR) 10-2015-0071460

(51) Int. Cl. H01H 9/28; B60R 13/00; E05B 83/18; H01H 3/12

(52) U.S. Cl. CPC H01H 9/285; H01H 3/12; B60R 13/005; E05B 83/18; H01H 2231/026

(57) ABSTRACT

An emblem integrated trunk switch module, wherein a trunk lock and a trunk switch are integrated with an emblem by mounting a push type push button for switching on and off a tact switch of a trunk switch for opening a trunk on an upper end of the emblem, and a push and rotation type push cover for finishing a front surface of the trunk lock on a lower end of the emblem.

### CROSS-REFERENCE TO RELATED APPLICATION

This application claims, under 35 U. S. C. §119(a), the benefit priority to Korean Patent Application No. 10-2015-0071460, filed on May 22, 2015 with the Korean Intellectual Property Office, the entire contents of which are incorporated herein by reference.

### TECHNICAL FIELD

The present disclosure relates to an emblem integrated trunk switch module. More particularly, it relates to an emblem integrated trunk switch module in which a trunk switch and a trunk lock are integrated with an emblem to improve a design of an external appearance of a trunk and to increase freedom in design.

### BACKGROUND

In general, a trunk for loading various cargos is provided at a rear side of a vehicle, and the trunk includes a trunk body defining a trunk space and a trunk lead for opening and closing the trunk body.

A trunk opening switch is installed in the trunk lead as an unlocking unit for unlocking the trunk lead from the outside of the trunk.

A trunk latch for locking and unlocking a trunk lead is provided in the trunk of the vehicle, and the trunk latch unlocks the trunk lead to open the trunk body when the trunk opening switch is operated.

In recent years, trunk opening switches have been installed in an emblem installed at a rear side of the vehicle, such that the truck opening switches are switched on and off by pressing or pulling the emblem.

Such emblem integrated trunk opening switches include various types such as a type of extracting an emblem (Korean Patent Application Publication No. 10-2012-0020712), a type of rotating an emblem (Korean Patent Application Publication No. 10-2012-0053914), and a type of pushing a front surface of an emblem (Korean Patent Application Publication No. 10-2014-0075374).

For example, FIG. 1 is a sectional view illustrating an emblem integrated trunk switch according to the related art, which has a structure in which an emblem button 100 is moved inwards and outwards to switch on and off a switch assembly 130 while being guided by a button stroke guide 120 on a switch body 110 of a front surface of the emblem button 100 as the emblem button 100 is pressed or released.

However, in the trunk switch according to the related art, a capillary phenomenon makes it difficult to discharge water when water is introduced between a button stroke guide and a switch body. If the introduced water is frozen, a button operation stroke significantly increases due to a wide area between the button stroke guide and the switch body, making it difficult to operate the trunk switch and making it impossible to operate the trunk switch at subzero temperatures when the switch is frozen.

Meanwhile, in recent years, vehicles having a design mounted on a rear bumper have been released. When such a design is applied, it is difficult to select the positions of the trunk switch and the trunk lock switch without damaging an external appearance of the vehicle.

### SUMMARY OF THE DISCLOSURE

Accordingly, the present disclosure has been made in an effort to solve the above-mentioned problems and provides an emblem integrated trunk switch module which improves a design thereof and enhances a degree of freedom in design by realizing a new form of a truck lock in which an upper end of an emblem performs a push button type trunk opening switch function and a lower end of the emblem is used after a cover is opened as the trunk lock is mounted on a lower end of the emblem.

The present disclosure also provides an emblem integrated trunk switch module which smoothly discharges water even when water is introduced and smoothly operates a switch even in low temperature freezing, thereby improving an operation performance of the switch by providing a drain structure on a front surface of an emblem body to guide flows of water and employing an under body formed of a rubber material to allow an operation of a switch even when water droplets are frozen.

In order to achieve the above-mentioned objects, the emblem integrated trunk switch module according to the present disclosure has the following features.

In accordance with an aspect of the present disclosure, there is provided an emblem integrated trunk switch module, wherein a trunk lock and a trunk switch are integrated with an emblem by mounting a push type push button for switching on and off a tact switch of a trunk switch for opening a trunk on an upper end of the emblem and a push and rotation type push cover for finishing a front surface of the trunk lock on a lower end of the emblem.

Here, the trunk switch may include: a body having a front surface to which the emblem is coupled and having a button hole at an upper end thereof, the body being installed in a trunk panel; a push button inserted into and positioned in the button hole of the body to be moved inwards and outwards while being resiliently supported by a spring, an upper body and a lower body coupled to a rear surface of the body; and a tact switch installed in the interiors of the upper body and the lower body to be switched on and off through contact with the push button.

The upper body may be composed of materials including a rubber. It passes through a rear surface of the push button to be coupled to the push button, and is movable while being flexibly deformed when the push button is moved.

It is preferable that the body has a water guide groove formed along a periphery of the button hole and a drain hole communicated with one side of the water guide groove, for discharging water to the outside.

The push cover may be inserted into and pressed by the cover hole at a lower end of the body, and may be supported to be rotated and moved inwards and outwards through a tether inserted into a tether hole at one side of a front surface of the body.

The push cover may open and close a front surface of the trunk lock through a fixing boss fastened to and released from a toggle type latch mounted on another side of a front surface of the body.

It is preferable that the body equipped with the push cover has a water guide groove formed along a periphery of the cover hole and a drain hole communicated with one side of the water guide groove, for discharging water to the outside.

The emblem integrated trunk switch module according to the present disclosure has the following advantages.

First, design may be improved and a degree of freedom in designing a trunk may be enhanced by integrating a trunk lock exposed to the outside of the trunk and a trunk switch with an emblem.

Second, an operation of a switch is not allowed when the switch is frozen at sub-zero temperatures according to the related art, but an operation of the switch is possible even when the switch is frozen according to the structure of the present disclosure.

Third, the structure of the switch is simple and requires low costs as compared with a rotation type switch.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a sectional view illustrating an emblem integrated trunk switch according to the related art;

FIG. 2 is a perspective view illustrating an emblem integrated trunk switch module according to an embodiment of the present disclosure;

FIG. 3 is a front view illustrating the emblem integrated trunk switch module according to the embodiment of the present disclosure;

FIG. 4 is a front view illustrating a body of the emblem integrated trunk switch module according to the embodiment of the present disclosure;

FIGS. 5a and 5b are sectional views illustrating operational states of a push button in the emblem integrated trunk switch module according to the embodiment of the present disclosure;

FIG. 6 is a perspective view illustrating a push cover of the emblem integrated trunk switch module according to the embodiment of the present disclosure; and

FIGS. 7a and 7b are front and sectional views illustrating operational states of the push cover in the emblem integrated trunk switch module according to the embodiment of the present disclosure.

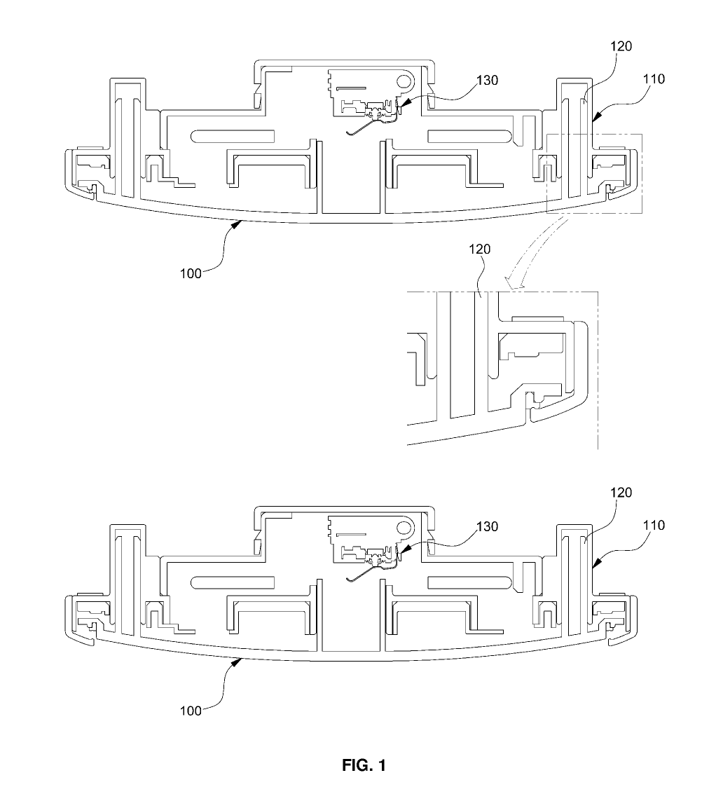

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, the present disclosure will be described in detail with reference to the accompanying drawings.

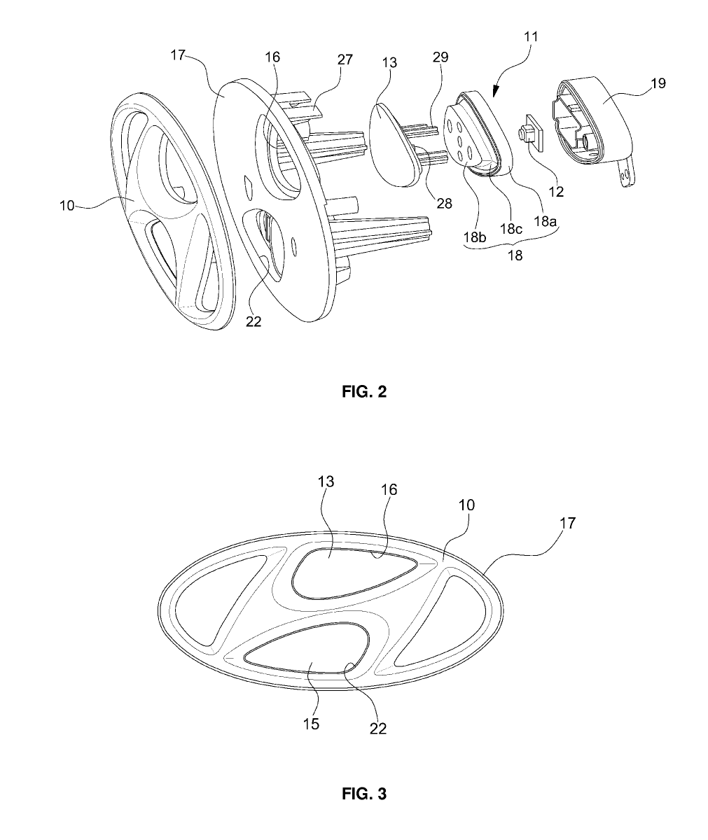

FIGS. 2 and 3 are perspective and front views illustrating an emblem integrated trunk switch module according to an embodiment of the present disclosure.

As illustrated in FIGS. 2 and 3, the emblem integrated trunk switch module has a structure in which a trunk lock and a trunk switch are integrated in an emblem, and a push cover may be opened and closed such that an upper end of the emblem may function as a trunk open switch which is operable even during low temperatures. Further, a lower end of the emblem may be used in an emergency situation, such as when a battery is discharged, so that a design in an external appearance of a trunk may be improved and design freedom may be enhanced.

To achieve this, the emblem integrated trunk switch module may include a trunk switch 11 for opening a trunk and a trunk lock 14 for locking the trunk. The trunk switch may be disposed at an upper end of the emblem 10 and the trunk lock 14 may be disposed at a lower end of the emblem 10.

The emblem integrated trunk switch module may be configured such that the trunk lock 14 and the trunk switch 11 are integrated in the emblem 10. Accordingly, the trunk may be opened by manipulating the trunk switch 11 at an upper end of the emblem 10, and the trunk may be locked and unlocked by manipulating the trunk lock 11 at a lower end of the emblem 10.

The trunk switch 11 includes a body 17 functioning as a module body. The body 17 is a support fixedly installed in a trunk panel (not illustrated), the emblem 10 having a predetermined shape is coupled to a front surface of the body 17. A button hole 16 and a cover hole 22 are formed at an upper end and a lower end of the body 17, and the push button 13 and the push cover 15 may be inserted into and positioned in the holes, respectively.

The body 17 may be inserted into the trunk panel through a clip 27, or the like, extending towards a rear surface thereof.

The trunk switch 11 includes the push button 13 as a switch control means. The push button 13 has the form of a plate having a shape and a size substantially corresponding to the shape and size of the button hole 16 in the body 17.

A switch boss 28 and a plurality of guide bosses 29 extending in parallel from the center and an outer periphery of the rear surface of the push button 13 towards the rear side are formed on the rear surface of the push button 13. The push button 13 is inserted into, and positioned in, the button hole 16 in the body 17 to be moved inwards and outwards.

The push button 13 is attached and coupled to a front surface of the upper body 18, that will be described below, through a rear surface thereof and is inserted into and fixed to a front hole of the upper body 18 through the guide bosses 29.

The switch boss 28 of the push button 13 passes through the front hole of the upper body 18 and is located on a rear surface of the upper body 18, and may contact a tact switch 12 installed in the interiors of the upper body 18 and the lower body 19.

That is, if the push button 13 is pressed, the switch boss 28 performs a switching operation while contacting the tact switch 12.

The guide bosses 29 of the push button 13 also pass through the front hole of the upper body 18, and are located on a rear surface of the upper body 18 and approach a wall surface of the lower body 19 to guide the push button 13 when the push button 13 is moved inwards and outwards.

Although not illustrated, a spring (not illustrated) is interposed between a rear surface of the push button 13 and the bottom surface of the lower body 19, such that the spring returns to an initial position before the push button 13 is pressed while there is no external force.

The trunk switch 11 includes an upper body 18 and a lower body 19 that function to accommodate the tact switch 12.

The upper body 18 and the lower body 19 are coupled to each other to form a convexo-concave structure, and constitute one sealed case (except for a hole for entrance and exit of a wire).

The tact switch 12, which contacts the switch boss 28 to be switched on and off, is located in the interiors of the upper body 18 and the lower body 19, and the tact switch 12 may be fixed to the lower body 19.

The tact switch 12 may be a PCB integrated switch and is electrically connected to an electrical wire for a vehicle through wiring, and the tact switch 12 may be a general tact switch applied to a trunk switch.

The upper body 18 has a waterproof function, is formed of a rubber material, and passes through a rear surface of the push button 13 to be flexibly deformed to be moved together with the push button 13 when the push button 13 is moved.

For example, the upper body 18 includes a rear fixed body 18a coupled to a rear surface of the body 17 and a front end of the lower body 19 in a convexo-concave manner and a front movable body 18b press-fitted and coupled to a rear surface of the push button 13. The fixed body 18a and the movable body 18b are integrally connected to each other by a deformed part 18c.

Accordingly, if the push button 13 is pressed, the movable body 18b may be moved together with the push button using an expansion/contraction operation of the deformed part 18c.

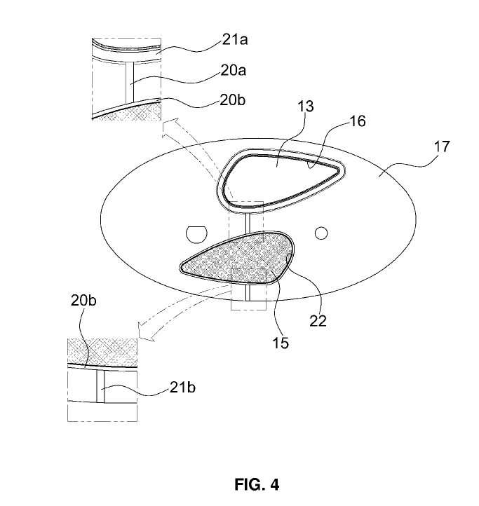

FIG. 4 is a front view illustrating a body of the emblem integrated trunk switch module according to the embodiment of the present disclosure.

FIG. 4 illustrates a structure in which water is guided to the outside of the emblem integrated trunk switch module when the water is introduced into the switch module, and illustrates a state in which the emblem 10 mounted on a front surface of the body 17 is removed.

Water guide grooves 20a and 20b are formed in the button hole 16 and the cover hole 22, formed in the body 17, along peripheries of the button hole 16 and the cover hole 22. Drain holes 21a and 21b for discharging water to the outside are formed in the water guide grooves 20a and 20b and connected to each other.

For example, a vertical drain hole 21a is formed between the water guide groove 20a formed in the upper button hole 16 and the water guide groove 20b formed in the lower cover hole 22. A drain hole 21b communicated with the outside of the body is formed at one side of a lower end section of the water guide groove 20b in the cover hole 22.

Accordingly, the water guided to the upper water guide groove 20a is discharged to the outside via the water guide groove 20a, the drain hole 21a, the water guide groove 20b, and the drain hole 21b.

The water guided downwards to the water guide groove 20b may be discharged to the outside through the water guide groove 20b and the drain hole 21b.

In this way, since the water guide groove and the drain hole are provided in the body, the water introduced through the push button and the front surface of the push cover is effectively guided and discharged to the outside, so that a freezing problem due to the residual water droplets may be addressed.

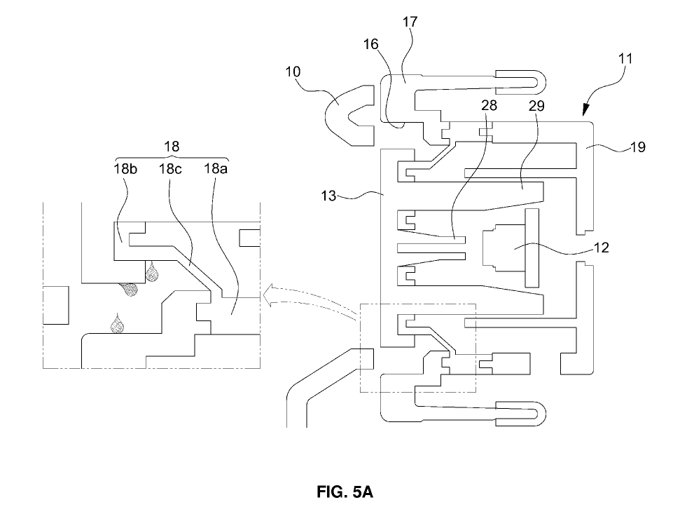

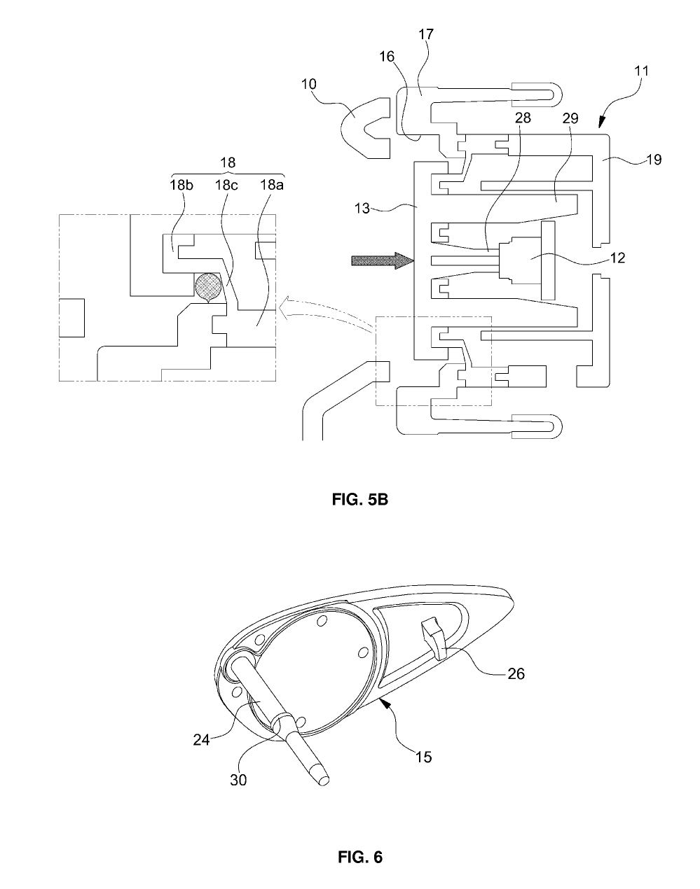

FIGS. 5a and 5b are sectional views illustrating operational states of a push button in the emblem integrated trunk switch module according to the embodiment of the present disclosure.

As illustrated in FIGS. 5a and 5b, if a front surface of the push button 13 is pressed when the trunk is opened, the upper body 18 on the rear surface of the trunk including the push button 13, that is, the entire movable body 18b is moved inwards. As a result, because the switch boss 28 of the push button 13 presses the tact switch 12, the trunk may be unlocked by switching on the tact switch 12.

Here, a process of unlocking the trunk by switching on the tact switch is the same as the conventional process, and a detailed description thereof will be omitted.

If the push button 13 that has been pressed is then released, it returns to an original state by a restoring force of the spring.

When water is introduced into an aperture (gap) between the push button 13 and the button hole 16, water may be prevented from being introduced into the interior of the body in which the tact switch 12 is present by the deformed part 18c of the upper body 18.

In particular, because the gap between a peripheral circumference of the push button 13 and an inner circumference of the button hole 16 in which the push button 13 is positioned is wide, water may be naturally guided to the drain hole without generating the capillary phenomenon.

If the water droplets are frozen, pieces of ice are also moved in the direction of a button stroke in correspondence with the deformation of the upper body 18 formed of a rubber material. Thus, an operation is possible in spite of freezing.

FIG. 6 is a perspective view illustrating a push cover of the emblem integrated trunk switch module according to the embodiment of the present disclosure.

As illustrated in FIG. 6, the push cover 15 is a means for finishing a front surface of the trunk lock 14 installed in the body 12, and has the form of a plate having a shape and a size substantially corresponding to the shape and size of the cover hole 22 in the body 17.

A fixing boss 26 extending towards the rear side, and a tether 24 having a bar shape and formed of a rubber material, are formed at opposite end parts of the rear surface of the push cover 15.

The push cover 15 is inserted into and positioned in the button hole 16 formed in the body 17, and may be inserted into the tether hole 23 formed in the body 17 through the tether 24 on a rear surface of the push cover 15 to be moved inwards and outwards.

Because an extraction prevention step 30, having a diameter larger than the diameter of the tether 24, is formed at a rear end of the tether 24, the push cover 15 including the tether 24 may be prevented from being extracted from the tether hole 23 as long as the push cover 15 is not compulsorily extracted (of course, the push cover 15 is compulsorily inserted using the characteristics of the rubber tether when being mounted).

The fixing boss 26 of the push cover 15 is fastened to, or released from, a toggle type latch 25 mounted on one side of a front surface of the body 17, that is, one side of the trunk lock 14 mounted to the body 17.

Here, the toggle type latch 25 is a known latch having a structure in which the toggle type latch 25 is fastened and released whenever it is pressed and the trunk lock 14 also is a known trunk lock. Thus a detailed description of an operation thereof will be omitted.

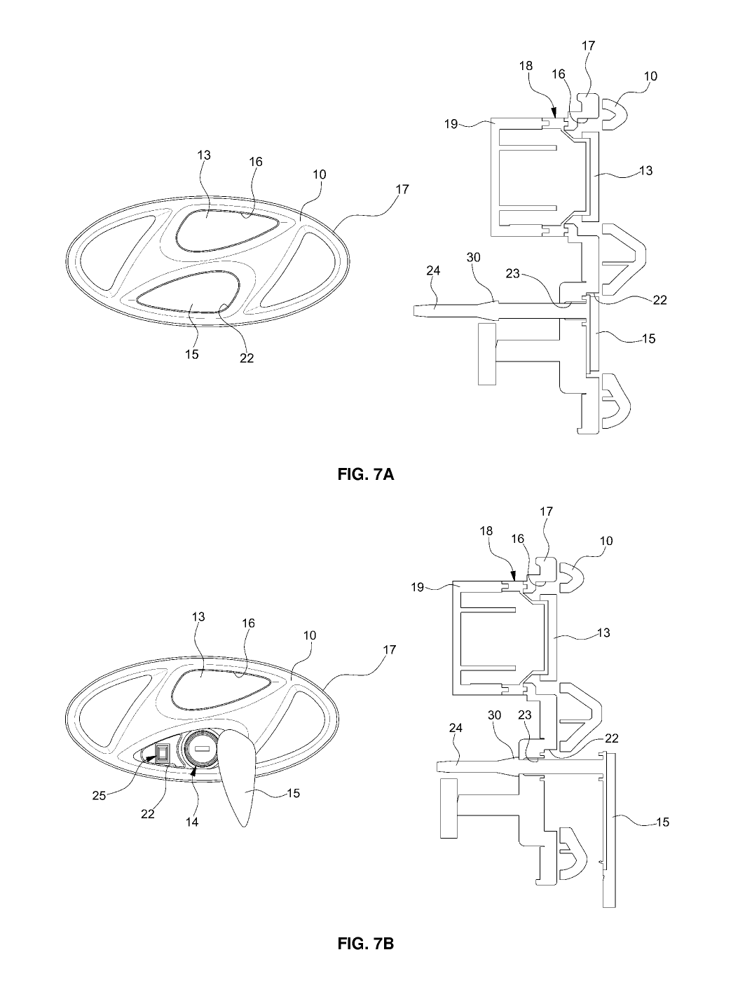

FIGS. 7a and 7b are a front view and a sectional view illustrating operational states of the push cover in the emblem integrated trunk switch module according to the embodiment of the present disclosure.

As illustrated in FIGS. 7a and 7b, the push cover 15 is supported by the tether 24 slidably inserted into the tether hole 23 of the body 17, and may be maintained closed or opened by using the fixing boss 26 coupled to or released from the toggle type latch 25 of the body 17.

First, in a description of a method of opening and closing the trunk lock push cover, if the push cover 15 slightly presses one end of the push cover 15, one end of the push cover 15 slightly protrudes outwards while the fixing boss 26 is released from the toggle type latch 25.

In this state, if the push cover 15 is rotated about the tether 14 to be leaned back while the protruding part of the push cover 15 is gripped and pulled by a hand, the trunk lock 14 is exposed, and if a vehicle key is inserted into the key hole of the exposed trunk lock 14, the trunk may be opened.

In this way, the present disclosure provides a new trunk switch module in which a trunk lock and a trunk switch are integrated in an emblem, thereby improving a design of an external appearance of the trunk and increasing a degree of freedom in design and improving convenience of the user by switching the trunk even if the switch is frozen.

What is claimed is:

1. An emblem integrated trunk switch module, wherein a trunk lock and a trunk switch are integrated with an emblem by mounting a push type push button for switching on and off a tact switch of a trunk switch for opening a trunk on an upper end of the emblem, and a push and rotation type push cover for finishing a front surface of the trunk lock on a lower end of the emblem.

2. The emblem integrated trunk switch module of claim 1, wherein the trunk switch comprises:
a body having a front surface to which the emblem is coupled and having a button hole at an upper end thereof, the body being installed in a trunk panel;
a push button inserted into and positioned in the button hole of the body to be moved inwards and outwards while being resiliently supported by a spring, an upper body and a lower body coupled to a rear surface of the body; and
a tact switch installed in the interiors of the upper body and the lower body to be switched on and off through contact with the push button.

3. The emblem integrated trunk switch module of claim 2, wherein the upper body passes through a rear surface of the push button to be coupled to the push button, and is movable while being flexibly deformed when the push button is moved.

4. The emblem integrated trunk switch module of claim 2, wherein the body has a water guide groove formed along a periphery of the button hole and a drain hole communicated with one side of the water guide groove for discharging water to the outside.

5. The emblem integrated trunk switch module of claim 1, wherein the push cover is inserted into and pressed by the cover hole at a lower end of the body, and is supported to be rotated and moved inwards and outwards through a tether inserted into a tether hole at one side of a front surface of the body.

6. The emblem integrated trunk switch module of claim 2, wherein the push cover is inserted into and pressed by the cover hole at a lower end of the body, and is supported to be rotated and moved inwards and outwards through a tether inserted into a tether hole at one side of a front surface of the body.

7. The emblem integrated trunk switch module of claim 1, wherein the push cover opens and closes a front surface of the trunk lock through a fixing boss fastened to and released from a toggle type latch mounted on another side of a front surface of the body.

8. The emblem integrated trunk switch module of claim 2, wherein the push cover opens and closes a front surface of the trunk lock through a fixing boss fastened to and released from a toggle type latch mounted on another side of a front surface of the body.

9. The emblem integrated trunk switch module of claim 1, wherein the body has a water guide groove formed along a periphery of the cover hole and a drain hole communicated with one side of the water guide groove, for discharging water to the outside.

10. The emblem integrated trunk switch module of claim 2, wherein the body has a water guide groove formed along a periphery of the cover hole and a drain hole communicated with one side of the water guide groove, for discharging water to the outside.
